(19) United States
(12) Patent Application Publication
(10) Pub. No.: US 2010/0150826 A1
(43) Pub. Date: Jun. 17, 2010

(54) MICROPOROUS METALS AND METHODS FOR HYDROGEN GENERATION FROM WATER SPLIT REACTION

(75) Inventors: Tomasz Troczynski, Vancouver (CA); Edith Czech, North Vancouver (CA)

Correspondence Address: CHRISTOPHER & WEISBERG, P.A., 200 EAST LAS OLAS BOULEVARD, SUITE 2040, FORT LAUDERDALE, FL, 33301, US

(73) Assignee: THE UNIVERSITY OF BRITISH COLUMBIA, Vancouver, BC (CA)

(21) Appl. No.: 12/063,375

(22) PCT Filed: Aug. 9, 2006
(86) PCT No.: PCT/CA06/01300

§ 371 Date: Mar. 11, 2008

Related U.S. Application Data
(60) Provisional application No. 60/706,913, filed on Aug. 9, 2005.

(51) Int. Cl. C01B 3/08; B32B 5/18; B22F 9/04; B22F 1/00; B22F 9/16; H01M 8/06

(52) U.S. Cl. 423/657; 428/613; 75/330; 75/343; 428/546; 429/421

(57) ABSTRACT

The present invention relates to hydrogen generating microporous metals, methods for preparing microporous metals, and methods for producing hydrogen from water using the metals and systems of the invention. In particular, microporous metals selected from the group comprising aluminum (Al), magnesium (Mg), silicon (Si), Iron (Fe) and zinc (Zn), capable of producing hydrogen upon reaction of the metal with water having a neutral pH are provided. Methods for preparing microporous metals comprising the steps of selecting a metal that is sufficiently electropositive (i.e. water reactive); and introducing microporosity in the selected metal by means of mechanical deformation, or metallurgical techniques, in order to generate the microporous metal are also provided, as is a method for producing hydrogen comprising reacting a microporous metal powder with water at a pH of between 4 and 10.

### FIELD OF THE INVENTION

The present invention pertains to the field of hydrogen generation, and in particular to methods for generating hydrogen from microporous metals.

### BACKGROUND

The generation of hydrogen utilizing inexpensive simple processes is becoming increasingly important. The increasing demand for hydrogen arises from the imminent paradigm shift to a hydrogen-based energy economy, such as in hydrogen fuel cells. This shift approaches as the worldwide need for more electricity increases, greenhouse gas emission controls tighten, and fossil fuel reserves wane. The attendant market for fuel generators addresses the near term lack of hydrogen supply infrastructure that is necessary for the proliferation of the hydrogen fuel cell. Hydrogen-based economy is the only long-term, environmentally benign alternative for sustainable growth. Over the last few years it is becoming more apparent that the emphasis on cleaner fuel will lead to use of hydrogen in a significant way. Providing that renewable energy sources, such as hydroelectricity or solar energy, are used to produce hydrogen through decomposition of water, there are no environmental threats produced by the hydrogen economy.

The common method to recover hydrogen from water is to pass electric current through water and thus to reverse the oxygen-hydrogen reaction, i.e. in water electrolysis. This method requires access to continued supply of electricity, i.e. typically access to a power grit. Another method involves extraction of hydrogen from fossil fuels, for example from natural gas, or from other liquid fuels such as methanol. These methods are complex and always result in residues, such as carbon dioxide, at best. And there is only so much fossil fuel available. In these reforming methods the resulting hydrogen must be somehow stored and delivered to the user, unless the hydrogen generation is performed “on-board”, close to the consumption system. Safe, reliable, low-cost hydrogen storage and delivery is currently one of the bottlenecks of the hydrogen-based economy.

In the art, controlled generation of hydrogen has been described. For example, several U.S. patents, describe controlled hydrogen generators that employ alkali metals (U.S. Pat. Nos. 4,356,163; 5,514,353; 3,716,416) or metal hydrides (U.S. Pat. No. 5,593,640), or iron (U.S. Pat. No. 5,510,201) and water, as well as a generator that employs hydrochloric acid and pure metal (U.S. Pat. No. 4,988,486). More recently, the controlled generation of hydrogen from spherical polyethylene-coated Na or NaH pellets (U.S. Pat. Nos. 5,817,157 and 5,728,464) has been described. This system comprises a container to hold the pellets and water, a hydraulic system for splitting open the pellets, and a hydrogen sensor and computer which provides a feedback loop for activating the pellet splitter.

The generation of hydrogen gas in an uncontrolled manner is also known (U.S. Pat. Nos. 5,143,047; 5,494,538; 4,072,514; 4,064,226; 3,985,865; and 3,966,895) in systems comprising mixtures of alkali or alkali earth metals and/or aluminum and water or aqueous salt solutions. These reactions are based on the fact that some metals spontaneously react with water to produce hydrogen gas. These are, for example, alkaline metals such as potassium (K) or sodium (Na). These metals can be used as water-split agents through a simple reaction, which proceeds spontaneously once the metal is placed in contact with water:

2K+2H₂O→2KOH+H₂ (A).

Similar reactions can be written for other alkali metals, e.g. Na. Unfortunately hydroxide chemicals (i.e. the residual KOH in the above reaction (A)) cause very high alkalinity of the resulting products, making them corrosive, dangerous to handle, and potentially polluting to the environment. Because the reaction (A) proceeds spontaneously and violently, the reactive metals must be always protected from undesirable contact with water when being stored or otherwise not directly and usefully used to generate hydrogen gas (i.e. the metals must also be protected from air which under normal conditions will contain water vapor). This increases the cost of the technology and adds safety and pollution problems. A further disadvantage is that the reaction products are not easy to handle and recycle.

Reaction (A) has an advantage in that the reaction products (i.e. KOH) continuously dissolve in the reacting water, and thus allow the reaction to continue until all metal reacts. A similar effect has been difficult to achieve with other reactive metals, such as aluminum, because in this case after reaction with water the metal containing reaction products, i.e. Al(OH)₃ or AlOOH, in combination with aluminum oxide, tend to deposit on the surface of the reacting metal and thus restrict access of reactants (e.g. water) to metal surface, eventually stopping the reaction. This “passivation” phenomenon is a fortunate property of reactive metals such as Al, as it preserves them in a substantially corrosion-free state in a wide variety of applications, as long as their environment is not too acidic or alkaline. At the same time, passivation does not allow the use of Al for the generation of hydrogen from water at close to neutral pH.

A number of variants of the water split reaction used to produce hydrogen have been described in the past to overcome these problems. In particular, U.S. Pat. Nos. 6,440,385 and 6,582,676 describe a process wherein Al continuously reacts with water to produce hydrogen (and aluminum hydroxide Al(OH)₃), in neutral or near-neutral pH range (pH=4-10). The reaction occurs in the presence of an effective amount of catalyst; wherein the metal (typically Al) and catalyst are blended into intimate physical contact; and wherein the catalyst is in the form of catalyst particles in the size range 0.1-1000 μm.

A number of types of catalysts are suggested in the art, namely non-soluble ceramic particles such as alumina or other aluminum ion containing ceramics (such as aluminum hydroxide), other ceramics such as MgO or SiO₂, but also calcium carbonate or hydroxide, carbon, and organic water soluble compounds such as polyethylene glycol (CA Pat. No. 2,418,823). Blending of the metal (such as Al) and the catalyst is made by pulverizing the metal and the catalyst to expose fresh surfaces of the metal. In addition to pulverization, the metal and the catalyst can be pressed together to form pellets after which, the pellets can be mixed with water.

European Patent No. 0 417 279 B1 teaches the production of hydrogen from a water split reaction using aluminum and a ceramic namely calcined dolomite, i.e. calcium/magnesium oxide. Once contacted with water, these oxides cause very substantial increase of pH (i.e. create an alkaline environment), which stimulates corrosion of Al with accompanying release of hydrogen. The system has all the disadvantages of water split reactions using alkaline metals, i.e. high alkalinity and difficult recyclability of the products. In one case, the Mg and Al are mechanically ground together to form a composite material which is then exposed to water (U.S. Pat. No. 4,072,514).

Continuous removal of the passivation layer on aluminum by mechanical means, in order to sustain aluminum assisted water split reaction, has also been described in the art (FR Pat. No. 2,465,683). This patent describes a method of automatic gas production by reaction of alkaline solution with metal-incorporating feeding without interruption of reaction and continuous metal cleaning applicable in producing hydrogen for energy source. For hydrogen production, aluminum on sodium hydroxide solution in water was used.

Metal-water systems including water-soluble inorganic salt (WIS) solutions have also been described in the art. For example, Suzuki (GB Patent No. 1,378,820) describes hydrogen production by reacting magnesium and water in the presence of potassium or sodium chloride. Similarly, GB Patent No. 1,420,048 outlines a process for producing hydrogen from a combination which comprises a mixture of metal, cobalt oxide and a water soluble chloride and GB Patent No. 1,496,941 teaches the manufacture of a magnesium composite capable of producing hydrogen generation upon contact of the composite with water or brine containing at least 1% of a WIS. In addition, the art discloses metal-catalyst compositions, such as aluminum-WIS compositions, and methods of producing hydrogen from water using catalyst-assisted reactions (PCT App. No. PCT/CA05/000546 and U.S. application Ser. No. 11/103,994).

The chemistry of aluminum exposed to water-soluble inorganic salt solutions, in namely, halide solutions, is also well represented in the art. E. McCafferty in “Sequence of steps in the pitting of aluminum by chloride ions” (Corrosion Science 45 (2003) 1421-1438) described that the pitting of aluminum involves a sequence of steps. The steps involved in the pit initiation process are considered to be adsorption of chloride ions at the oxide surface, penetration of the oxide film by chloride ions, and Cl⁻-assisted dissolution which occurs beneath the oxide film at the metal/oxide interface. It is proposed that chloride ions penetrate the oxide film by a film dissolution mechanism in addition to Cl⁻-penetration through oxygen vacancies. Corrosion pit propagation leads to formation of blisters beneath the oxide film due to localized reactions which produce an acidic localized environment. The blisters subsequently rupture due to the formation of hydrogen gas in the occluded corrosion cell. Calculation by McCafferty et al of the local pH within a blister from the calculated hydrogen pressure within the blister gives pH values in the range 0.85 to 2.3.

The general conclusion drawn from the art is that corrosion by pitting in aluminum alloys in an aggressive medium, such as aerated solution of NaCl at 3.5% and at pH 5.5, is a complex process. It can be affected by diverse experimental factors such as the pH, the temperature, the type of anion present in the solution, and the physico-chemical characteristics of the passive layer. The adsorption of aggressive ions such as Cl⁻ into the faults in the protective film, and their penetration and accumulation in these imperfections, is considered one of the triggering factors of the process of nucleation of pitting. Pits may develop as a result of a process of hydrolysis which gives rise to a local reduction of the pH which, in turn, impedes the subsequent process of re-passivation. Another factor which is associated with the susceptibility of aluminum to pitting corrosion and other forms of localized corrosion is the electrochemical nature of the intermetallic phases. Generally, pitting corrosion occurs when the aqueous environment contains aggressive anions, such as chlorides, sulphates or nitrates, especially of alkaline metals such as sodium or potassium.

In addition to the above-mentioned metal-assisted water split reactions, methods for generating hydrogen from water utilizing mechano-corrosive reactions and metallic liquid suspensions have also been described by the art. Watanabe et al. (US Patent Application No. 20040208820), for example, discloses a method of producing hydrogen gas by causing friction and mechanical fracture of a metal under water to produce hydrogen gas, while Gerard et al. (FR Patent No. 2,658,181) teaches a reactive fluid comprising a metallic powder suspension in water and a stabilizing additive, capable of releasing hydrogen from the decomposition of water upon initiation of a reaction.

Accordingly, there is a continuing need for safe and effective hydrogen generating systems that overcome the problems of prior hydrogen generating systems, for example passivation.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide microporous metals and methods for hydrogen generation from water split reaction. In accordance with an aspect of the present invention, there is provided a microporous metal capable of producing hydrogen upon reaction of said metal with water having a neutral or near-neutral pH.

In accordance with another aspect of the invention, there is provided a method for preparing a microporous metal capable of producing hydrogen upon reaction of said metal with water, said method comprising the steps of selecting a metal that is sufficiently electropositive that its bare surface will react with water; and introducing micropores in the selected metal.

In accordance with another aspect of the invention, there is provided a method for producing hydrogen comprising reacting a microporous metal with water at a pH of between 4 and 10 to produce hydrogen.

### BRIEF DESCRIPTION OF THE FIGURES

Further features objects and advantages will be evident from the following detailed description of the present invention taken in conjunction with the accompanying drawings which illustrate specific embodiments of the invention and are not intended to limit the scope of the invention in any way.

FIG. 1 shows a plot illustrating hydrogen generation from Al—NaCl (50 wt %) powder mixtures and from washed-out aluminum powders that were formerly ground with 50 wt % sodium chloride (BM=ball milling);

FIG. 2 shows an X-ray diffraction pattern of washed-out material (formerly Al—NaCl (50 wt %) powder mixture);

FIG. 3 shows EDS analysis of washed-out aluminum from (formerly Al—NaCl (50 wt %) powder mixture);

FIG. 4 shows a plot illustrating hydrogen generation from washed-out aluminum powders that were formerly ground with 50 wt % sodium chloride (BM=ball milling);

FIG. 5 shows a plot illustrating hydrogen generation from washed-out aluminum powder that was formerly ground with various water-soluble salts (50 wt %) (BM=ball milling);

FIG. 6 shows a SEM micrograph of Al—KCl (50 wt %) after 15 min ball-milling (×1000);

FIG. 7 shows a SEM micrograph of 15 min ball-milled and leached-out Al (previously Al—KCl (50 wt %)) (×1000);

FIG. 8 shows SEM micrograph of Al—KCl (50 wt %) after 15 min ball-milling (×5000);

FIG. 9 shows SEM micrograph of 15 min ball-milled and leached-out Al (previously Al—KCl (50 wt %)) (×5000);

FIG. 10 shows XPS survey scan of Al—NaCl (50 wt %) powder mixture, ball-milled for 15 min;

FIG. 11 shows XPS survey scan of 15 min ball-milled and leached-out Al powder (previously Al—NaCl (50 wt %));

FIG. 12 shows XPS survey scan of commercially available (as-received) Al powders;

FIG. 13A shows High resolution O 1 s XPS spectra of leached-out Al and Al—NaCl (50 wt %) powder mixtures, ball-milled for 15 min, compared to as-received Al powders; and

FIG. 13B shows High resolution Al 2 p core-level XPS spectra of leached-out Al and Al—NaCl (50 wt %) powder mixtures, ball-milled for 15 min, compared to as-received Al powders.

### DETAILED DESCRIPTION OF THE INVENTION

The present invention provides microporous metals and metal systems for use in the production of hydrogen gas through the water split reaction. The invention further provides methods of preparing the microporous metals of the invention and methods for producing hydrogen gas comprising reacting the resulting metals with water. The microporous metals and methods of the present invention allow for the use of these metals for the generation of hydrogen from water at neutral or near-neutral pH. As would be understood by a worker skilled in the art, the microporous metals, systems and method of producing hydrogen of the present invention are contemplated for use in conjunction with devices requiring a hydrogen source.

### DEFINITIONS

Unless defined otherwise, all technical and scientific terms used herein have the same meaning as commonly understood by one of ordinary skill in the art to which this invention belongs.

As used herein, the term “about” refers to a +/−10% variation from the nominal value. It is to be understood that such a variation is always included in any given value provided herein, whether or not it is specifically referred to.

The term “additive” as used herein, refers to a substance or mixture of substances that may be added to a microporous metal system in order to enhance the water-split reaction.

The term “catalyst,” as used herein, refers to a substance or mixture of substances that can increase or decrease the rate of a chemical reaction without being consumed in the reaction.

As used herein, the term “deforming agent” or “agent” refers to a suitable substance, compound or composition capable of forming microporous structures in a source metal upon mechanical deformation (e.g. mixing by hand and/or machine).

The term “mechanical deformation,” as used herein, refers to metal deformation occurring as a result of mixing a metal with a deforming agent.

As used herein, the term “metal” refers to a non-Group 1 metal that is sufficiently electropositive that its bare surface will react with water, thereby generating hydrogen.

The term “milling,” as used herein, refers to various types of milling techniques including, but not limited to, Spex milling, vibratory-milling, ball-milling, and attrition milling.

As used herein, the term “mixing” refers to various types of techniques, for instance, hand mixing or milling used to combine two or more components. These techniques are useful for combining metals and agents; agents and additives; and metals, agents and additives, as well as other contemplated combinations.

The term “pre-milling,” as used herein, refers to the milling of a deforming agent in advance of metal-agent mixing.

The term “pure” or “purified,” as used herein, refers to a microporous metal or combination of metals free of deforming agents or containing trace amounts, i.e. <0.05% wt, of a deforming agent.

As used herein, the term “substantially pure” or “substantially purified” refers to a microporous metal or combination of metals comprising <1% wt of a deforming agent.

### Microporous Metals

The present invention provides microporous metals. These microporous metals facilitate the production of hydrogen from water, upon the reaction of microporous metals with water. In particular, the present invention provides for metals treated to be microporous, which when contacted with water having a neutral or near-neutral pH (i.e. a pH between about 7 and 10), produce hydrogen gas through the water-split reaction. Where the microporous metals are substantially pure they are essentially free of deforming agents (i.e. contain <1% of a deforming agent).

Without being limited to any particular theory or mechanism, the formation of micropores in select metals may interfere with, prevent, destabilize or otherwise counter the effects of passivation on hydrogen generation, thereby facilitating the water split reaction in the absence of catalysts and/or additives. As detailed herein, techniques such as casting-solidification metallurgy, powder metallurgy, evaporation-condensation metallurgy, and mechanical deformation processing (i.e. through vibromilling or other milling or deformation methods) of metals with certain deforming agents, produce the desired microporous morphology that is associated with hydrogen generation. In contrast to the metal-assisted water split reactions disclosed in the art, and as demonstrated by the accompanying examples, hydrogen generation using the microporous metals of the invention is possible once the desired microstructure is achieved, thereby no longer requiring catalysts and/or additives to initiate and/or sustain the metal-assisted water split reaction.

### 1) Reactive Microporous Metals

### i) Pore Size, Density and Distribution

For effective metal-assisted water split reactions, the water-reactive metals of the present invention comprise at least one micropore, which upon contact with water having a neutral pH (i.e. pH 4 to 10), facilitates hydrogen generation. As would be understood by those of skill in the art, reaction rate, yield and duration of the reaction may be optimized by pore size, pore density and pore distribution, which may be measured by such art-recognized techniques as physical gas adsorption, mercury intrusion porosimetry, chemical gas adsorption and helium pycnometry. Depending on the technique used to prepare the metal, micropores may be introduced at the surface of the metal or throughout the entire metal (i.e. surface and core). The pores of the metal should be substantially accessible to the reactants, e.g. water, in order to be active. Thus, the micropores in the metal are either substantially open micropores (i.e. not enclosed or closed off from the environment), or become substantially open, as the reaction proceeds, to facilitate hydrogen generation.

A worker skilled in the art would appreciate that the micropores may have a number of different sizes and morphologies including, but not limited to, a substantially circular, elongated, or irregular shape. In accordance with one embodiment of the present invention, the micropores have a substantially circular shape. In accordance with another embodiment of the present invention, the micropores have an irregular shape, e.g. elongated shape in the form of a channel. In yet another embodiment of the present invention, the micropores vary in shape throughout the metal. In a further embodiment of the invention, the micropores have a diameter of at least 0.01 μm. In accordance with yet a further embodiment of the invention, the diameter of the micropores is from about 0.01 to about 5 μM. In accordance with another embodiment of the invention, the diameter of the micropores is from about 0.5 to about 1 μm. In accordance with yet another embodiment of the invention, the diameter of the micropores is from about 0.5 to about 5 μm. In accordance with a further embodiment of the present invention, the micropores have a diameter of at least 0.01 μm and a depth of at least 1 μm.

With respect to volume, and in accordance with one embodiment of the invention, the micropores have a volume of at least 1000 nm³. In accordance with another embodiment of the invention, the volume of the micropores is from about 0.5 to about 1.8 μm³. In accordance with yet another embodiment of the invention, the volume of the micropores is from about 0.5 to about 0.9 μm³. In accordance with a further embodiment of the invention, the volume of the micropores is from about 0.9 to about 1.8 μm³.

As noted above, and in addition to pore diameter size and volume, the density or number of micropores per unit area, or overall volume fraction of the pores in the solid, may affect the water-split reaction. As pore density or the number of pores per unit area may be difficult to measure and monitor, the overall volume fraction of the pores provides a more convenient means of measurement. Accordingly, in one embodiment of the invention, the pore volume fraction of the micropores is from about 0.05 to about 0.80. In another embodiment of the invention, the pore volume fraction of the micropores is from about 0.10 to about 0.60. In yet another embodiment of the invention, the metals of the present invention are characterized as being highly porous, for example, having a pore volume fraction of from about 0.6 to 0.8.

As mentioned, it is contemplated that by modifying the porosity of the metal, hydrogen generation can be controlled to make it suitable for a desired application. For example, to have a controlled and slow reaction rate, i.e. in cases where a continuous supply of chemically generated hydrogen for low power devices, such as safety signals etc. is desired, microporosity can be optimized for the desired application using methods herein described.

### ii) Types Of Metals

For the purpose of the present invention, the source metal may be selected from a non-Group 1 metal that is sufficiently electropositive that its bare surface will react with water to effect the water split reaction, thereby generating hydrogen. Non-limiting examples of suitable metals include aluminum (Al), magnesium (Mg), silicon (Si), iron (Fe) and zinc (Zn). Accordingly, in one embodiment of the present invention, the metal is selected from the group comprising aluminum (Al), magnesium (Mg), silicon (Si), iron (Fe) and zinc (Zn). In another embodiment of the present invention, the metal is aluminum (Al). In addition, metal combinations have been contemplated. Thus, in another embodiment of the invention there is provided a microporous metal composition comprising two or more metals selected from the group comprising aluminum (Al), magnesium (Mg), silicon (Si), iron (Fe) and zinc (Zn).

iii) Forms of Metal

The form in which the microporous metals of the instant invention are used are not specifically fixed. Non-particulate forms may include coatings, rods, foils, and inserts, in addition to geometrical forms known to persons skilled in the art that are suitable for use with chemical reactors for hydrogen generation. Various sources of metals used in the preparation of particulate microporous metals include, but are not limited to, powders and granules. Where the source utilized is in the form of a powder or granule, the microporous metal for use in the water split reaction may be present in the form of a powder having particles with a size between about 0.01 and 10,000 μm. Thus, in accordance with one embodiment of the invention, the microporous metal powder is in the form of particles having a size between about 0.01 and 10,000 μm. In accordance with another embodiment of the invention, the microporous metal powder is in the form of particles having a size between about 0.01 and 1,000 μm. In accordance with another embodiment of the invention, the microporous metal powder is in the form of particles having a size between about 0.01 and 500 μm. In accordance with another embodiment of the invention, the microporous metal powder is in the form of particles having a size between about 0.01 and 250 μm. In accordance with another embodiment of the invention, the microporous metal powder is in the form of particles having a size between about 0.01 and 100 μm.

### iv) Surface Morphology and Specific Surface Area

The surface morphology and specific surface area (SSA) of the microporous metals of the present invention may be characterized using such art-recognized techniques as SEM (Scanning Electron Microscopy) and BET (Specific Surface Area Measurement using the Brunauer-Emmett-Teller (BET) theory). As demonstrated by the accompanying examples, the morphology of source metals may undergo significant changes during the preparation of the microporous metals. The micorporous metals of the present invention, for example, may become highly porous, undergo conformational changes and may be characterized by an increase in specific surface area. Where the metals have been prepared by mechanical deformation followed by leaching, as described below, the resulting microporous metal may take on a thin and cold-welded foil fragment morphology. Furthermore, the individual particles may vary in size and exhibit an irregular or agglomerated shape. It should be recognized that particle shape and surface morphology is dependent on the source of the metal and the process by which the microporous metal is prepared, accordingly, other particle shapes and surface morphologies, often complex and difficult to describe, are herein contemplated.

As further demonstrated by the accompanying examples, the specific surface area (SSA) of a microporous metal may be greater than that of the source metal from which it is derived. The SSA of a microporous metal may increase, for example, from about 1 to about 1000 fold compared to its source metal. Thus, in accordance with one embodiment of the invention, there is provided a microporous metal having a specific surface area (SSA) from about 1 to about 1000 fold the SSA of its source metal. In accordance with another embodiment of the invention, there is provided a microporous metal having a specific surface area (SSA) from about 1 to about 50 fold the SSA of the source metal. In accordance with yet another embodiment of the invention, there is provided a microporous metal having a specific surface area (SSA) from about 50 to about 100 fold the SSA of the source metal. In accordance with still another embodiment of the invention, there is provided a microporous metal having a specific surface area (SSA) of about 32 fold the SSA of the source metal. Where specific values are desirable, there is provided a microporous metal having an increase in SSA of more than about 1 m²/g as compared to the source metal. The specific surface area of the microporous metal may, for example, increase by more than about 1 m²/g to about 15 m²/g following its preparation.

Given the foregoing, it will be apparent to those of skill in the art that conformational changes to the surface of the microporous metals may increase surface area as well as the accessibility of reactants, e.g. water, to the metal surface, thereby facilitating and/or enhancing hydrogen generation during the water split reaction.

### v) Metal Purity and Elemental Composition

The metals of the present invention are either pure, or substantially pure microporous metals or alloys of metals. Where the metals have been prepared by mechanical deformation, as described herein, the microporous metals may contain less than 0.05% or less than 1% of a deforming agent. The near surface layer may additionally comprise elements such as oxygen and is, therefore, referred to as the metal oxide layer (metal_{oxide}). As would be apparent to those of skill in the art, the elemental composition of this layer, which may be determined by such art-recognized techniques as XPS (X-Ray Photoelectron Spectroscopy), varies depending on the source of the metal and the nature of the microporous process by which the metal is prepared. The near-surface composition of mechanically deformed leached microporous metal, for example, may consist predominantly of oxygen (approx. 48%), as depicted in Table 3.

In the art, it is generally understood that the structure, composition and thickness of the oxide layer largely influences the corrosion behaviour of a metal in an aqueous environment. While the microporous metals of the present invention can be free of a passivation layer and/or immune to the formation of a passivation layer during the water split reaction, the presence of an oxide layer on the surface of a microporous metal is not preventative in facilitating hydrogen generation, as is evidenced by the accompanying examples. The surface of the microporous metal may, therefore, comprise a thinner, thicker or equally proportionate oxide layer as compared to that of the source metal from which it was derived and still effectively generate hydrogen during the water split reaction.

### 2) Methods for Preparing Reactive Microporous Metals

The present invention additionally provides methods for preparing microporous metals. The final microstructure of the metal (i.e. micro- or nano-porous structure) is key to sustaining the rapid, high-yield metal-water reaction accompanied by hydrogen release. A number of techniques for achieving such microstructure are contemplated herein. In particular, means for introducing micropores in select metals include metallurgy and mechanical deformation techniques, such as milling, manipulation of molten metals, wet or chemical etching, or vapour deposition techniques. In view of the selection of practical applications, some methods may be more suitable because of lower cost, and other methods may be more suitable because of secondary requirements, such as size, shape or geometry of the microporous metal. Accordingly, the present invention provides a method for preparing a microporous metal comprising the following steps:
a) selecting a metal that is sufficiently electropositive that its bare surface will react with water; and
b) introducing micropores in the selected metal.

In one embodiment of the invention, micropores are introduced in the selected metal by metallurgy or mechanical deformation.

### i) Mechanical Deformation

For effective micropore formation, one embodiment of the present invention comprises providing source metal (e.g. in powder, granule or particulate form), and mechanically combining or mixing the metal with a deforming agent to produce an intermediate microporous metal composition. The microporous metal composition is then purified by removing the agent from the composition in order to render a microporous metal. Thus, in accordance with one embodiment of the invention there is provided a method for preparing a microporous metal powder comprising the steps of:
a) providing metal particles;
b) selecting a deforming agent suitable for micropore formation in said metal particles;
c) combining the metal particles and the agent to produce an intermediate microporous composition; and
d) removing the agent from the composition to render a pure or substantially pure microporous metal powder.

a) Providing Metals

The metal utilized during mechanical deformation may be selected as outlined herein. For example, the metal may be a non-Group 1 metal, such as a metal selected from the group comprising aluminum (Al), magnesium (Mg), silicon (Si), iron (Fe) and zinc (Zn). As it is preferential to mechanically deform metals of granule or particulate form, source powders may be purchased from suppliers such as Alcoa (US) or Alcan (Canada and Europe), in a variety of particle sizes. Alternatively, granules and particles of selected metals can be formed using standard techniques known in the art.

b) Selecting Deforming Agents

As illustrated by the examples, the deforming agent plays a key role in micropore formation during mechanical deformation. At present, selection criteria are based on both physical and chemical characteristics. Accordingly an agent may be selected in light of characteristics that can; a) facilitate its removal from the intermediate composition; and b) optimize microporosity during metal preparation. Deforming agents may include organic or inorganic agents, and may include, but are not limited to citric acid, short chain organic polymers (e.g. sugars or PEG), ice, dry ice, PVA, organic waste and water-soluble inorganic salts (WIS). Specific deforming agents may, for example, be selected from the group comprising: 1) chlorides such as NaCl, KCl, CaCl₂; 2) nitrates such as NaNO₃, and 3) other salts including sulphates and carbonates. Suitable salts of other metals and salts of non-metal cations are also contemplated as being within the scope of this invention. For example, NH₄Cl, is suitable as an agent in the compositions of the present invention. Thus, in one embodiment of the invention there is provided a method for preparing a microporous metal powder wherein the deforming agent is selected from the group consisting of citric acid, sugar, PVA, organic waste, ice, dry ice, PEG, NaCl, KCl, NH₄Cl, CaCl₂ and NaNO₃. In another embodiment of the invention there is provided a method for preparing a microporous metal powder comprising selecting two or more deforming agents from the group consisting of citric acid, sugar, PVA, organic waste, ice, dry ice, PEG, NaCl, KCl, NH₄Cl, CaCl₂ and NaNO₃

For the purposes of the present invention, one or more of the following factors may lend to the selection of a suitable deforming agent.

Solubility

When using a soluble agent, the solubility of a deforming agent affects its ease of removal (leaching out) from the intermediate composition. As such, agents may be selected according to their solubility. Deforming agents such as water soluble inorganic salts (WIS) having a solubility in water in excess of 5×10⁻³ mol/100 g, may be readily removed from the intermediate composition and are therefore representative of suitable soluble deforming agents. Although solubility in water is preferred due to convenience, low cost and environmental factors, solubility in other solvents such as alcohols is not beyond the scope of the present invention.

Size

Where optimization of microporosity or ease of production is key, the deforming agent utilized may be in the form of a powder, particle or granule having a size between about 0.01 and 10000 μm. In accordance with the present invention, the deforming agent may additionally be pre-treated in order to optimize micropore formation during mixing. Thus, contemplated herein is the pre-milling of a deforming agent prior to combining or mixing the metal and deforming agent. For the purpose of the present invention, the methods of pre-milling include, but are not limited to, Spex milling, vibratory-milling, ball-milling, and attrition milling.

Both the pre-milling techniques used to pre-treat the agent and the duration of pre-milling affect particle size. Accordingly, in one embodiment of the invention, the pre-milling time is from about 5 min to about 30 min. In another embodiment of the invention, the pre-milling time is from about 5 min to about 15 min. In another embodiment of the invention, the pre-milling time is from about 15 min to about 30 min.

Melting and Sublimation

The present invention also contemplates the removal of the deforming agent through evaporation (sublimation) or melting. In the case of sublimation, high-vapour pressure agents and decreased-pressure environment can be selected to accelerate the removal process. Such deforming agents are characterized by van der Waals bonding (as opposed to ionic or covalent bonding), and include, but are not limited to, organic materials such as short-chain organic polymers such as polyethylene glycol. In the case of removal by melting, agents having melting points significantly lower than the melting point of the metal are typically selected. Additionally, once molten, the liquid agent should not wet the microporous metal, in order to facilitate ease of removal from the micropores of the metal. Non-limiting examples of such low-melting point microporosity creating agents include short chain organic polymers, and low-melting inorganic salts. In extreme cases, where processing takes place at sub-zero temperatures, solid water (ice) or solid carbon dioxide (“dry ice”) may be also used, wherein agent removal is simply achieved by allowing the temperature of the microporous composition to increase to ambient, i.e. room, temperature.

c) Combining Metal and Deforming Agent for Micropore Formation

Once the metal and deforming agent have been selected, the metal particles and agent are combined or mixed to prepare an intermediate micropore composition. This may be achieved by a variety of ways known in the art including hand or mechanical mixing. During mixing, the metal particles and agent come into intimate physical contact. It is expected that the particle size of the initial components in the mixture will have an influence on final state of the metal powder. It is also expected that the type of equipment used for the mixing will have a bearing on the final state of the metal powder. Hand mixing is laborious and hydrogen production is generally less than that obtained from using a metal powder produced by milling. Accordingly, in one embodiment of the invention the metal and agent are milled.

Milling

As contemplated by the present invention, one or a combination of milling methods including, but not limited to, Spex milling, vibratory-milling, ball-milling, and attrition milling (as well as other methods), may be employed to produce the intermediate microporous composition. As would be understood by a worker skilled in the art, the larger the fraction of the open porosity of the metal and the number of micropores formed, the greater is the surface area of the metal exposed to water, and thus the higher the rate of the hydrogen generating reaction (i.e. larger amount of the metal reacts with water in unit time), and the higher the yield of the reaction (i.e. larger amount of the metal reacts with water).

Time

The duration of processing, e.g. milling or mixing time, may also affect micropore formation and consequently hydrogen production. As would be appreciated by a worker skilled in the art, longer milling generally produces finer porosity of the metal (this is a strong function of the deformation characteristics of the metal such as yield stress and strain hardening), but does not necessarily affect the fraction of pores in the metal. This is due to the plastic nature of metals and the tendency for some pores to collapse at longer milling time. Accordingly, each metal will have specific parameters under milling conditions. As illustrated by the examples, specific conditions for aluminum micropore formation, and the effects of these parameters on hydrogen generation have been determined. Given these factors, the length of mixing, for instance milling time, may be predetermined by a worker skilled in the art in order to obtain the desired microporosity in the selected metal. Accordingly, in one embodiment of the invention, the milling time is from about 7.5 min to about 4 hrs. In another embodiment of the invention, the milling time is from about 7.5 min to about 20 min. In another embodiment of the invention, the milling time is from about 20 min to about 30 min. In another embodiment of the invention, the milling time is from about 30 min to about 40 min. In another embodiment of the invention, the milling time is from about 50 min to about 60 min.

Ratio

The ratio of metal to deforming agent used during mixing operations may additionally affect micropore formation, and subsequently the rate of the metal-assisted water split reaction. As is with the case of milling time, each metal has specific deformation characteristics relating to the ratio of components. Appropriate ratios for a given metal can be readily determined by a worker skilled in the art. In one embodiment of the invention, the metal and deforming agent are mixed in a ratio of between about 1000:1 and about 1:1000 by weight. In another embodiment of the invention, the metal and agent are mixed in a ratio of between about 100:1 and about 1:10 by weight. In another embodiment of the invention, the metal and agent are mixed in a ratio of between about 95:5 and about 10:90 by weight. In accordance with another embodiment of the invention, the metal and agent are mixed in an approximately 1:1 ratio by weight. In accordance with another embodiment of the invention, the metal and agent are mixed in an approximately 50:50 ratio by weight. In accordance with another embodiment of the invention, the metal and agent are mixed in an approximately 30:70 ratio by weight.

The amount of agent relative to the metal may also be calculated as a percentage of weight. For example, the amount of deforming agent mixed with the metal can be from about 0.1 to about 99% wt. Thus in one embodiment, the agent is present in an amount from about 0.1 to about 40% wt. In another embodiment, the agent is present in an amount from about 40 to about 50% wt. In yet another embodiment, the agent is present in an amount from about 50 to about 90% wt.

d) Removal of Deforming Agent

The deforming agents of the present invention may be removed from the intermediate composition by known suitable means or processes, in order to render a pure or substantially pure microporous metal powder. As defined herein, pure microporous metals are understood to be free of deforming agents or contain trace amounts, i.e. <0.05% wt, of a deforming agent, while substantially pure microporous metals contain <1% wt of a deforming agent. Noteworthy is that only partial removal of the deforming agent from the microporous metal will also render the metal suitable for the reaction of hydrogen generation. Accordingly, in one embodiment of the invention the microporous metal contains >1% wt of the deforming agent.

Non-limiting examples of purification processes include dissolution, leaching, filtering, evaporation, sublimation or burning out. Of course, selection of an appropriate removal technique is based on the physical and/or chemical characteristics of the deforming agent, as well as the nature of the mixing process. Furthermore, the recovered agent may be recycled to process another batch of metal to create microporosity.

Where the deforming agent is soluble in water or another solvent, conditions such as leaching time, leaching temperature and leaching methods, may be optimized as would be understood by those skilled in the art. In one embodiment of the invention, it would therefore be contemplated that washing out (leaching) of a water soluble agent could be performed by techniques including water immersion, glass rod stirring and/or magnetic stirring, shaking, or sonicating in cold water (e.g. at about 12° C.); cold water being utilized in order to avoid initiation of the hydrogen generating reaction.

The amount of the deforming agent recovered during the removal process may be calculated by methods known to those skilled in the art. In the case of agent removal by leaching, for example, the amount of agent removed from the intermediate microporous composition may be determined by water evaporation and/or the weighing of residue in the sample. Chromatographic, spectrophotometric, X-ray powder diffraction (XRD) and Energy Dispersive Spectroscopy (EDS) analysis, as well as other technologies known in the art, may be employed in determining the amount of agent remnants present in the washed-out metal powders.

As a result of the purification process, about 90 to about 99.95% of the deforming agent is removed from the intermediate microporous composition. Accordingly, in one embodiment of the invention about 90 to about 99% of the deforming agent is removed from the intermediate microporous composition. In another embodiment of the invention, about 90 to about 99.95% of the agent is removed from the intermediate microporous composition. In yet another embodiment of the invention, about 99% to about 99.95% of the agent is removed from the intermediate microporous composition. In a further embodiment of the invention, >99.95% of the deforming agent is removed.

### ii) Metallurgy (Porogenesis)

There are many other methods for effectively forming micropores in metals. Microporous metals may be achieved via metallurgical techniques such as the manipulation of molten metal, for instance, in combination with gas (i.e. gas-assisted spraying and foaming) or with gas-forming solids (e.g. metal foaming after mixing). Non-limiting examples of methods for forming micropores in molten metal include, thermospraying, spray forming and microfoaming. Accordingly, in one embodiment of the invention there is contemplated a method for preparing microporous metals comprising the steps of:
a) providing molten metal; and
b) introducing microporosity by thermo spraying, spray forming, or microfoaming.

a) Thermal Spraying

For the purposes of the present invention thermal spraying, which includes such variations as arc spraying, plasma spraying, HVOF and flame spraying, refers to a process in which finely divided metal particles are deposited in a molten or semi-molten condition on a substrate (any suitable material to which a thermal spraying deposit is applied) to form a spray deposit. During this process, it is possible to introduce micropores as well as other molten materials.

Although thermal spraying, also known as thermo spraying, is typically used to apply metal deposits onto a substrate, i.e. rods, plates foils etc., the present invention additionally contemplates collecting microporous metals in the form of powder, granule or particulate, resulting from the thermo spraying process. Thus, in one embodiment of the invention, the microporous metal particles are prepared by: (a) fluidizing a metal in an upwardly spiraling current of air to give homogeneous distributed individual particles in a bed of air at a temperature below the melting point of the metal such that the metal remains approximately at its melting point throughout the spraying; and (b) cooling to solidify the particles for collection. In another embodiment of the invention, the microporous metal particles are deposited on a substrate by: (a) fluidizing a metal; (b) spraying the resulting molten metal onto the substrate in the form of droplets; and (c) cooling to solidify the microporous metal on the substrate.

As would be understood by those skilled in the art various forms of thermo spaying may be utilized to prepare microporous metal particles. Arc spraying, for example, refers to a thermal spraying process using an arc between two consumable electrodes of surfacing materials as a heat source and a compressed gas to atomize and propel the surfacing material to the substrate. Plasma spraying refers to thermal spraying process in which a nontransferred arc is utilized as the source of heat that ionizes a gas which melts and propels the coating material to the substrate. In the flame spray process, the raw material in the form of a single wire, cord or powder, is melted in an oxygen-fuel gas flame. This molten material is atomised by a cone of compressed air and propelled towards the substrate. The thermal spray process is often purposely manipulated to introduce porosity into the sprayed material, such as in the case of deposition of thermal barrier coatings.

b) Spray Forming

Spray forming is a direct, single-step forming process which combines aspects of atomisation and thermal spray technology for the bulk conversion of a liquid metal or alloy in to a near net-shape. It differs from conventional thermal spray processes (plasma, arc spraying etc.) in that deposition rates are considerably higher (several tens of kgs per minute) and free-standing products up to several tonnes in weight can be produced in relatively short times. In one instance, spray-forming steel involves a process called Osprey. During the Osprey method, steel is melted in a crucible using two induction furnaces and is then atomized in a spray chamber under a protected atmosphere. A specially designed spray head is used to deposit the semi-liquid steel onto a substrate. Like in thermal spraying, it is more difficult to produce dense materials than porous materials by spray forming, due to the nature of the melting-spray-solidification process.

As mentioned above, advantage of spray forming is the high solidification speed of the metal. This allows for a production of highly alloyed materials, which until recently only have been possible with the powder metallurgy process. As with thermo spraying, additional components may be introduced into the molten metal during spray forming. It is therefore contemplated that spray forming is a suitable method for the production of microporous metals according to the present invention.

Spray forming (or thermal spraying) for processing of microporous metals can be relatively easily integrated into metallurgical smelting process, e.g. instead of casting ingots for further processing, the molten metal (with or without additives) is sprayed directly into the collection container.

c) Microfoaming

The process of micro-foaming is also envisioned by the present invention. Here, open-cell foam structure resembles the milled/leached structure of the previously described mechanical processes. Metal foaming involves heating a volatile metal with a metal to be foamed (e.g. a mercury-aluminium alloy, or metal hydride such as titanium hydride). During heating, the two metals are contained within a pressure vessel, and heated to a temperature above the vaporisation temperature of the more volatile component. The mercury is prevented from fully vaporising by the pressure within the vessel. Heating continues to the melting temperature of the metal to be foamed, when an aluminium melt is formed which is supersaturated with mercury gas. The entire molten mass is subsequently removed from the pressure vessel, and the mercury vaporises fully and expands within the molten metal, to produce a microporous foam which is then allowed to cool and solidify. Use of metal hydrides for the same purpose is very “environmentally friendly”, as after completion of the process, the gaseous phase (H₂) can be simply combusted to water. Accordingly, microfoaming is yet another method suitable for generating the microporous metals of the instant invention.

iii) Wet Etching

Another method for effectively forming micropores in metals is the process of wet-etching. As would be understood by the skilled worker, pores having a defined diameter are drilled or etched into the surface of a selected metal. Given the costs and amount of labour involved in wet-etching, this process is typically reserved for experimental purposes. It is not however excluded from commercial applications, with respect to the present invention.

iv) Chemical Etching

Further contemplated is the process of chemical etching. During chemical etching, microporosity is introduced by way of the corrosive properties innate to an applied compound. Corrosive solvents, for example, are used to etch micropores in the surface of source metals such as rods, plates, foils, powders, granules and particles and are, therefore, envisioned as tools for generating the microporous metals described herein.

Methods for Generating Hydrogen from Microporous Metals

The present invention further provides methods for producing hydrogen from water by reacting microporous metals with water. In particular, the present invention provides metals deformed to comprise micropores, to be contacted with water having a neutral or near-neutral pH (i.e. a pH between about 4 and 10), wherein hydrogen gas is generated.

In addition to the structural characteristics specific to micropore formation, one skilled in the art would understand that other factors including, but not limited to, pH, temperature and reaction pressure may affect hydrogen generation in the methods of the present invention. In particular, the microenvironment formed within the pores due to the generation of H₂, may directly influence reaction rates, hydrogen yields and duration. In this way, modification to the micropore environment (i.e. the localized conditions) may influence the efficiency of hydrogen production, although the globally measured acidity and temperature remains largely unchanged. As indicated above, the following factors may affect hydrogen generation in the present invention, potentially by influencing the microenvironment of the pores.

### i) Reaction Pressure

As illustrated by the examples, hydrogen generation can occur at ambient pressures of ˜1 atm. The water split reaction can additionally occur under high pressure, for instance, at pressures ranging between about 1 and about 1000 atm. Thus, in accordance with one embodiment of the invention there is provided a method for producing hydrogen utilising a microporous metal wherein the method is conducted at a pressure between about 1 and about 1000 atm. In accordance with another embodiment of the invention, there is provided a method for producing hydrogen utilising a microporous metal wherein the method is conducted under ambient (˜1 atm) pressure. In accordance with yet another embodiment of the invention, there is provided a method for producing hydrogen from a microporous metal wherein the method is conducted at a pressure between about 10 and about 1000 atm.

It would be understood by those skilled in the art that hydrogen generation through water split reaction can proceed equally vigorously in confined environments at increased pressures. Thus, in accordance with one embodiment of the invention, the method of generating hydrogen utilising a microporous metal is conducted in either an open or a closed system. In accordance with another embodiment of the invention, the closed system is a pressurized reactor. In addition, the method may be conducted in a confined environment under high pressure, and after passing through a pressure reduction stage, the H₂ is supplied to the user device at normal pressure (˜1 atm). This variant of the process allows retention of relatively large amount of ready-to-use H₂ in a suitable high-pressure container, which is decompressed as needed to supply the low-pressure container as required by the user device (e.g. fuel cell).

As indicated above, the water split reaction using microporous metals can be conducted in pressurized reactors allowing the overall water temperature to exceed 100° C., and the overall pressure of gas (water plus hydrogen) to exceed 1 atm. Thermodynamic calculations indicate that in pressurized environments the general water split reaction of Metal+H₂O->MetalOH+H₂ may provide extremely high pressures of gas, providing all kinetic factors, such as passivation, are removed.

### ii) pH and Temperature

As is known in the art, temperature and pH affect hydrogen generating water split reactions. With respect to the present invention, these factors may be increased or decreased in such a way so as to produce hydrogen at a predetermined or desired rate. Typically, the water-split reaction using a microporous metal reaction occurs at a pH of between about 4 and 10, as determined for the bulk solution (away from the micropores). Thus, in one embodiment of the invention, there is provided a method of producing hydrogen using a microporous metal reaction wherein the water pH is between 4 and 10. In another embodiment there is provided a method for producing hydrogen using a microporous metal reaction wherein the water pH is between about 4 and 9. In another embodiment there is provided a method for producing hydrogen using a microporous metal reaction wherein the water pH is between about 4 and 5. In another embodiment there is provided a method for producing hydrogen using a microporous metal reaction wherein the water pH is between about 5 and 6. In another embodiment there is provided a method for producing hydrogen using a microporous metal reaction wherein the water pH is between about 6 and 7. In another embodiment there is provided a method for producing hydrogen using a microporous metal reaction wherein the water pH is between about 7 and 8. In another embodiment there is provided a method for producing hydrogen using a microporous metal reaction wherein the water pH is between about 8 and 9. In another embodiment there is provided a method for producing hydrogen using a microporous metal reaction wherein the water pH is between about 9 and 10. In another embodiment there is provided a method for producing hydrogen using a microporous metal reaction wherein the water pH is about 6.5.

With respect to temperature, there is provided a method of producing hydrogen using a microporous metal reaction under ambient pressure, wherein the temperature of the water is between about 22 and 100° C. Thus in accordance with one embodiment of the invention, there is provided a method for producing hydrogen using a microporous metal reaction wherein the temperature of the water is between about 22 and 100° C. In accordance with another embodiment, there is provided a method of producing hydrogen using a microporous metal reaction wherein the temperature of the water is between about 22 and 40° C. In accordance with another embodiment, there is provided a method of producing hydrogen using a microporous metal reaction wherein the temperature of the water is between about 40 and 55° C. In accordance with another embodiment, there is provided a method of producing hydrogen using a microporous metal reaction wherein the temperature of the water is between about 55 and 100° C. In accordance with another embodiment, there is provided a method wherein the temperature of the water is about 55° C.

For reactions performed in closed systems, or at pressures above ambient, there is provided a method of producing hydrogen using a microporous metal reaction wherein the overall temperature of the water exceeds 100° C.

iii) Water Types

Given the various types of environments (marine, air, land etc.) in which hydrogen powered devices may operate, a number of water types may be used in the inventive method of the present invention. Non-limiting examples of water types include, fresh, spring, tap, distilled, filtered and marine. In one embodiment of the invention, the water of the method is selected from the group comprising fresh, tap, distilled, filtered and marine. In another embodiment of the invention, the water of the method is tap water.

### iv) Additives

Although the microporous metal systems of the present invention do not require catalysts and/or additives in order to initiate or sustain a water-split reaction, it would be understood by those skilled in the art that additives can optionally be applied to the current microporous metal system in order to enhance or otherwise modify the water-split reaction. This is of particular interest where water conditions, including temperature and pH, warrant adjustment for optimizing reaction start rates, yields and duration. Given that the water-split reaction optimally occurs under relatively warm (55° C.) and alkaline conditions, additives that aid to increase or enhance hydrogen production in cold or less alkaline water conditions, are contemplated, for example. Select metals may therefore be combined with one or more additives in order to enhance hydrogen generating reactions, or start the reactions at less favourable conditions, e.g. in cold environments. Small amounts of additives including alkaline or alkaline earth metals, such as but not limited to, K, Li, Na, Ca, Mg, for instance, can significantly increase the reaction of the microporous metal under less desirable water conditions. In addition, the use of surface-active additives, such as polyethylene glycol (PEG), are contemplated.

In light of the foregoing, one embodiment of the present invention provides for a method for hydrogen generation comprising the following steps:
1. Providing a microporous metal powder, optionally comprising one or more additives; and
2. Exposing the powder provided in step (1) to water, either in the form of liquid or vapour.

In the second step, the exposure of the metal powder produced in step (1) to water, either liquid or vapour, assures access of water to the maximum porosity and surface area at the outset and during the reaction, in order to maximize the reaction rate and yield. As illustrated by the examples, and in accordance with one embodiment of the invention, loose powders are contained in a container permeable to water and gas (the “tea-bag” arrangement). Other forms of containment, however, are also within the scope of the present invention.

In one embodiment of the invention, the method for hydrogen generation yields 800 cc H₂/g reactive metal or more. In another embodiment of the invention, the method for hydrogen generation yields 900 cc H₂/g reactive metal or more. In yet another embodiment of the invention, the method for hydrogen generation yields 1000 cc H₂/g reactive metal or more.

### Microporous Metal Systems

The present invention further provides for microporous metal systems. As would be understood by the skilled artisan, the systems and method of producing hydrogen may be used in conjunction with devices requiring a hydrogen source. Accordingly, the systems described in the present invention may accelerate introduction of hydrogen-derived power to consumer electronics (e.g. laptop computers), medical devices or transportation. In particular, use of such hydrogen source to power implantable medical device requires that chemistry of such device has minimal impact on the organism in case of failure of such device. The use of neutral or near-neutral water, and microporous metal in such device conforms to this requirement. It is understood that the microporous metals employed in the inventive systems are as outlined above. Similarly, the metals of the systems are prepared as previously described. Thus, for the purpose of the present invention, the microporous metal systems employed for the hydrogen generating water split reaction comprise:
a) a microporous metal according to the present invention;
b) water; and
c) means for containing the system.

The microporous systems of the present invention are particularly suited for application in hydrogen generation for mobile devices, and the use of the instant systems in hydrogen fuel cells for powering a wide variety of mobile devices is contemplated. Furthermore, as there is no carbon dioxide/monoxide produced in metal assisted water split reaction, this reaction is especially important for application in fuel cells, where a small amount of CO contaminant in hydrogen may poison the additive and make the cell dysfunctional. Accordingly, in one embodiment of the invention, there is provided a microporous metal system, adapted for use in a device powered by hydrogen. In yet another embodiment, there is provided a microporous metal system, adapted for use in a hydrogen fuel cell.

In another example, the water-split reaction using microporous metals is used as an emergency H₂ supply to a larger system which is normally supplied through the “grid” of H₂ refuelling stations (e.g. liquid H₂ or high-pressure H₂). It is known that widely accessible grid of H₂ re-fuelling stations will not exist for the next several decades, and it will take even longer to make the grid comparable to today's existing supply system for gasoline. As such, access to portable emergency supply systems such as H₂, e.g. for the user to travel between the scarce H₂ re-fuelling centers may be important. The microporous systems of the present invention can therefore be employed for as such an emergency H₂ supply, as part (attachment) to the “regular” pressurized or liquid H₂ supply system.

The invention will now be described with reference to specific examples. It will be understood that the following examples are intended to describe embodiments of the invention and are not intended to limit the invention in any way.

### EXAMPLES

The above general description of the methods of the present invention is supported through the examples of experimental results. The experiments were carried out to measure the volume of hydrogen gas produced in the reaction of washed-out aluminum powder with water, at ambient pressure (˜1 atm). The aluminum powder was mechanically mixed with a deforming agent and then the agent washed-out to achieve a highly porous, substantially pure Al powder.

The specific examples presented below describe scientific data collection at ambient pressures of ˜1 atm. The amount of hydrogen (cc) released after 1 hr of reaction was measured by water displacement and normalized to 1 g of Al reactant. To determine variations in the reaction rates additional measurements in shorter time intervals were also undertaken.

H₂ generation yields obtained from such “washed-out Al”-water reactions were related to the theoretical hydrogen generation given by the reactions:

Al+3H₂O=Al(OH)₃+1.5H₂

Al+2H₂O=AlOOH+1.5H₂

Both reactions yield theoretically (at 25° C.) 1359 cc H₂/1 g Al. These results were compared to H₂ yield from the previously disclosed Al—Al₂O₃ powder mixture, and to the previously disclosed Al/WIS (Water-Soluble Inorganic Salts) mixtures.

In all experiments pure aluminum (99.7% Al, common grade, 40 μm average particle); Alumina: Al₂O₃, Al6 SG, Alcoa; Al:Al₂O₃ ratio=50:50 wt %), Sodium chloride: NaCl (99.9%, Fischer Chemicals, 300 μm average particle size, 1.1 g) and/or Potassium chloride: KCl (technical grade, 250 μm average particle size) were used.

All salts were first pre-ball-milled in the SPEX mill for 5 min, then mixed with aluminum powder in 50:50 wt % ratio, and then again Spex-milled for 15 min. The mechanically mixed Al-deforming agent powder mixtures were washed in cold tap water. These conditions were selected as the solubility of these salts in cold water is very high but the hydrogen generation reaction is very limited.

The powders were packed in paper filter bag and immersed in tap water at approximately pH=6 and T=55° C. for hydrogen generation.

### Example 1

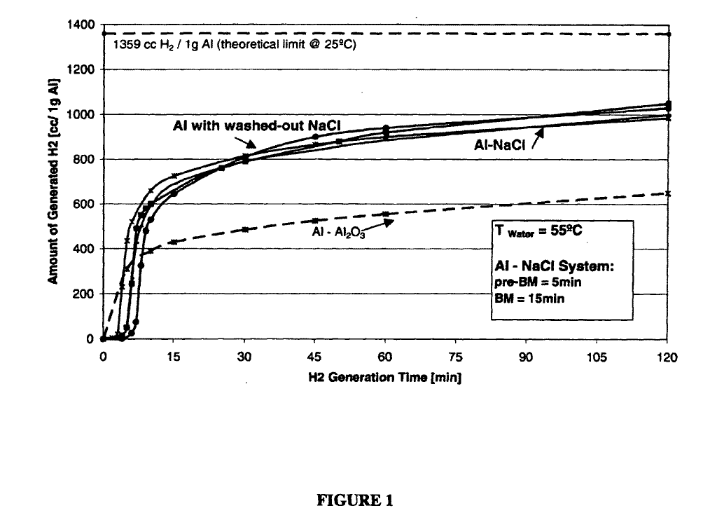

Sodium chloride, NaCl, (99.9%, Fisher Chemicals, 300 μm average particle size, 1.1 g) was first pre-milled in the Spex mill for 5 minutes. Thereafter, the pre-ball milled (pre-BM) sodium chloride was mixed with the standard Al powder (99.7% Al, common grade, 40 μm average particle size, 1.1 g) and Spex-milled together for another 15 minutes. 2 g of the resulting powder mixture was enclosed in a paper filter bag and immersed in tap water at approximately pH=6 and T=55° C. Two samples were prepared for reference purpose. The total amount of hydrogen released after 1 hr by Sample #1 was 885 cc/1 g of Al and by Sample #2 900 cc/1 g of Al (average 892.5 cc/1 g of Al) which accounts to 66% of the total theoretical reaction yield value (FIG. 1; as indicated by arrows). The generated hydrogen amount surpassed the amount of hydrogen generated by the standard Al—Al₂O₃ system by 60%.

### Example 2

The Al—NaCl powder mixture was prepared as described in Example 1. After milling, 2 g of the powder was placed in a beaker and washed in 100 ml cold tap water (Tₛₜₐᵣₜ=12° C.) by start stirring with a glass rod occasionally to dissolve and wash the salt out of the aluminum matrix. Two powder samples were prepared (Sample #3 and Sample #4). The immersion time of the powder in cold water was approx. 10 minutes. The remaining insoluble powder (i.e. predominantly Al) was filtered into a paper filter bag and still wet immersed in tap water at approximately pH=6 and T=55° C. for hydrogen generation. The total amount of hydrogen released after 1 hr by Sample #3 was 920 cc/1 g Al and by Sample #4 940 cc/1 g of Al (average 930 cc/1 g of Al) which accounts to 68% of the total theoretical reaction yield value (FIG. 1; as indicated by arrows). The generated hydrogen amount from the washed-out aluminum powders was slightly higher compared to the amount of hydrogen generated from Al—NaCl system described in Example 1. Furthermore, the use of washed-out microporous metal yields between about 1.0 and 1.7× more H₂ than is produced in the known Al—Al₂O₃ system, after 1 hr of reaction at 55° C.

The removal of the deforming agent from the Al—NaCl system can be technologically important as it reduces the total weight of the powder used for water split reaction by ˜50%, while maintaining efficient hydrogen production. Separation of the deforming agent from the microporous metal may decrease the overall weight of solid reactants (metal) by a factor of about 1.2 to 4 (depending on the amount of deforming agent used to generate microporosity in the metal). As such, the necessity to include in the “fuel” almost half-weight in non-participating agents of the water split reaction (which impacts the overall competitiveness of the process) is eliminated. Thus, washed-out microporous metals employ less water, are substantially pure and have no reaction products other than hydrogen.

The amount of the dissolved salt, contaminated with small Al particles that could not be captured by the filter, was determined by water evaporation and weighing of the residue. For both samples about 95% (0.950 g) of the salt were recovered.

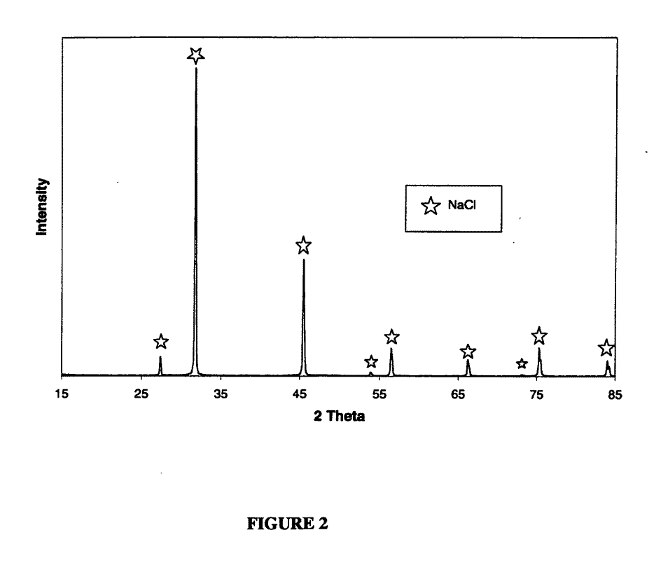

X-ray powder diffraction (XRD) analysis performed on the washed-out material of Sample #4 (FIG. 2) indicated that only one phase, sodium chloride, was present in the dried residue. XRD is sensitive to all crystalline phases in the powder, and is commonly used in materials science for qualitative and quantitative analysis of the phase of powdered materials. This result indicates also that the amount of Al or Al(OH)₃ in the washed-out material, if any, is under the detection limit of the XRD method, which is about 1 wt % for this system.

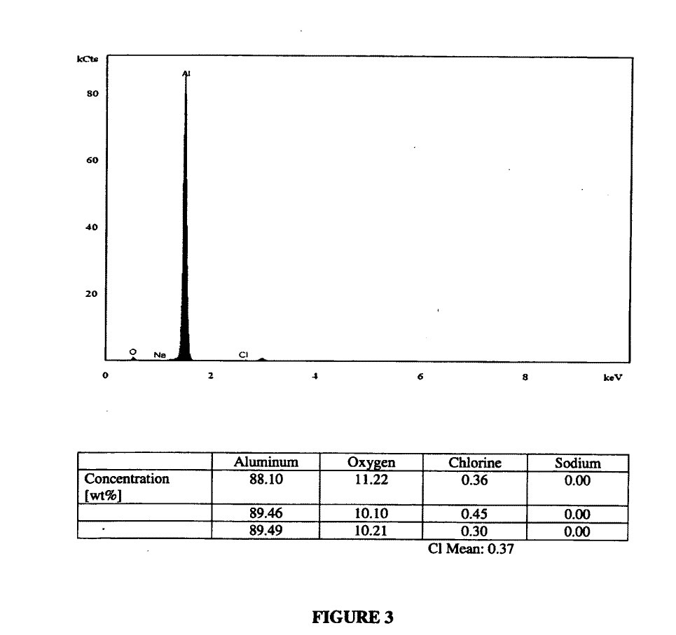

In addition, the amount of salt remaining in the washed-out aluminum powder or salt adhered on its surface (salt remnants from aqueous solution) was determined using Energy Dispersive Spectroscopy (EDS) analysis. EDS is indicative of the presence of elements building on any given phase, with sensitivity of about 0.05 wt % for this system. The elemental concentration of the air-dried aluminum powders of Sample #4 is given in FIG. 3. Only about 0.37 wt % (average value) of chlorine was detected in the washed-out Al powder that was previously ground with 50 wt % sodium chloride.

### Example 3

To further reduce the amount of salts in the washed-out aluminum, Al-deforming agent powder mixtures were stirred during the wash-out process and kept for an extended period of time in the cold water.

Two Al—NaCl (50 wt %) powder mixtures, Sample #5 and #6, were prepared as described in Example 1 and washed in 100 ml cold tap water (Tₛₜₐᵣₜ=12° C.) by either stirring with a glass rod occasionally or by using a magnetic stirrer to substantially dissolve the salt out of the aluminum matrix. The immersion time of the powder in cold water has been extended to 2 hours and 3 hours (see Table 1 below). The remaining powder (i.e. predominantly Al) was filtered into a paper filter bag. The solution, which contained also the smallest Al particles that could not be captured by the filter, was placed in a dryer at 65° C. for at least 24 hours. The amount of the dissolved salt was determined by weighing of the residue after water evaporation.

As a result of the extended wash-out the amount of the recovered NaCl salt from Al—NaCl system increased further from 95% to more than 98.5% (0.985 to 1.033 g, see Table 1). The dried remnants included small amounts of Al and/or Al(OH)₃.

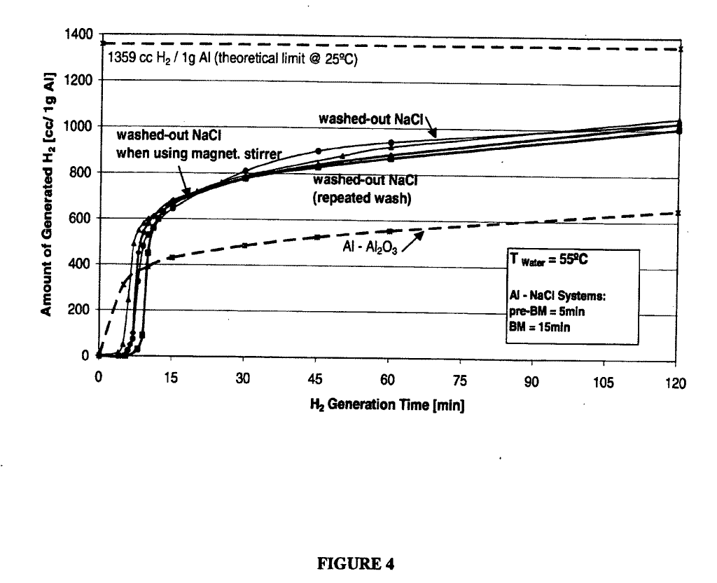

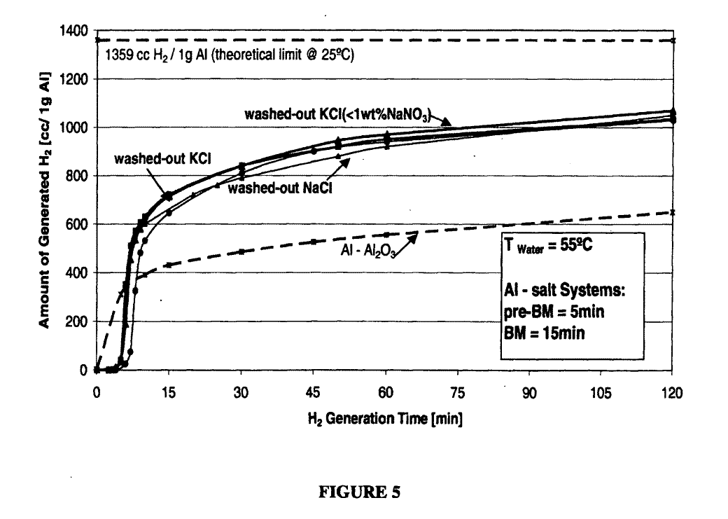

The total amount of hydrogen released by Sample #5 and #6 after 1 hr was 885 cc/1 g Al which accounts for 65% of the total theoretical reaction yield value (FIG. 4, as indicated by arrows). The generated hydrogen amount is comparable to the amount of hydrogen generated from Al—NaCl system that was described in Example 1.

TABLE 1
Amount of washed-out NaCl salt and
applied washing-out methods.

| Al—NaCl (1:1) | | Total time of | Amount of |
|---|---|---|---|
| 2 g powder | NaCl washing-out | Al—NaCl powder | washed-out |
| mixture | method | in cold water | salt [g] |
| Sample #3 | Stirring with a | 10 min | 0.950 |
| and #4 | glass rod | | |
| (Example 2) | occasionally | | |
| Sample #5 | Stirring with a | 3 hrs | 0.985 |
| | glass rod | | |
| | occasionally | | |
| Sample #6 | Using a magnet/ | 2 hrs | 1.033 |
| | stirrer | | |
| | for 1.5 hrs | | |

### Example 4

To further reduce the amount of salts in the washed-out aluminum, the Al-deforming agent powder mixtures were rinsed repeatedly, stirred during the wash-out process and kept for an extended period of time in cold water.

The Al—NaCl (50 wt %) powder mixture was prepared as described in Example 1. After milling, 2 g of the powder was placed in a beaker and washed three times to dissolve the salt more thoroughly out of the aluminum matrix—each time using approximately 50 ml cold tap water (Tₛₜₐᵣₜ=12° C.)—by alternating the washing methods (stirring with a glass rod (first and third wash) and stirring with a magnetic stirrer for approx. 30 min (second wash)). The immersion time of the powder in cold water totalled approx. 2 hours. The remaining insoluble powder (i.e. predominantly larger Al particles) was filtered into a paper filter bag and still wet immersed in tap water at approximately pH=6 and T=55° C. for hydrogen generation.

The total amount of hydrogen released after 1 hr was 870 cc/1 g of Al which accounts for 65% of the total theoretical reaction yield value (FIG. 4, as indicated by arrows). The generated hydrogen amount from more thoroughly washed-out aluminum powders is thus comparable to the amount of hydrogen generated from Al—NaCl system that was described in Example 1 and also to the amount of hydrogen generated from washed-out Al described in Examples 2 and 3 (3% total H₂ yield difference).

The repeatedly washed-out and air-dried Al powder was characterized using EDS. It was found that the amount of chlorine in the more thoroughly washed Al powder was reduced to as low as 0.06 wt % Cl (mean value), Table 2.

TABLE 2
EDS analysis on repeated washed-out Al powder
(formerly Al—NaCl(50 wt %) powder mixture)

| | Aluminum | Oxygen | Chlorine | Sodium |
|---|---|---|---|---|
| Concentration [wt %] | 89.96 | 10.04 | 0.00 | 0.00 |
| | 88.55 | 11.32 | 0.12 | 0.00 |
| | 90.70 | 9.24 | 0.07 | 0.00 |

Cl mean: 0.06

### Example 5

To investigate hydrogen generation from washed-out aluminum powders after milling with other water-soluble inorganic salts, sodium chloride has been replaced with potassium chloride, KCl, and potassium chloride tainted with ≦1 wt % sodium nitrate; this powder is designated as KCl(<1 wt % NaNO₃).

1.1 g of KCl (technical grade, 250 μm average particle size) was pre-milled in the Spex mill for 5 min either in pure form or together with traces of NaNO₃ (<1 wt %). Thereafter, the pre-treated potassium chloride was mixed with standard Al powder (99.7% Al, common grade, 40 μm average particle size, 1.1 g) and Spex-milled together for another 15 minutes.

After milling, 2 g of the powder was placed in a beaker and washed in cold water as described in Example 4. The remaining insoluble powder was enclosed in a paper filter bag and still wet immersed in tap water at approximately pH=6 and T=55° C. for H₂ gas generation.

The total amount of hydrogen released from the washed-out aluminum powder after 1 hr was 950 cc/1 g of Al from the Al—KCl system and 970 cc/1 g of Al from the Al—KCl(<1 wt % NaNO₃) system. This accounts for 70%, or 71%, respectively, of the total theoretical reaction yield value. The generated hydrogen amount surpassed slightly (by 4% to 5%) the amount of hydrogen generated by the washed-out Al from the Al—NaCl system, and by 74% the amount of hydrogen generated by the standard Al—Al₂O₃ system.

### Example 6

Ball-milled and leached-out Al-deforming agent powders were characterized by using SEM (Scanning Electron Microscopy), BET (Specific Surface Area Measurement using the Brunauer-Emmett-Teller (BET) theory) and XPS (X-Ray Photoelectron Spectroscopy) methods.

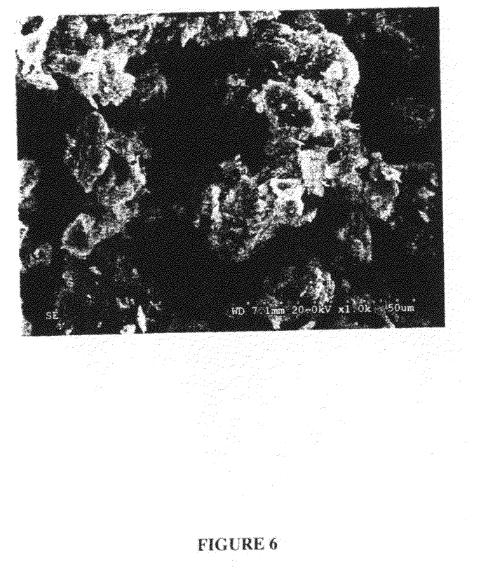

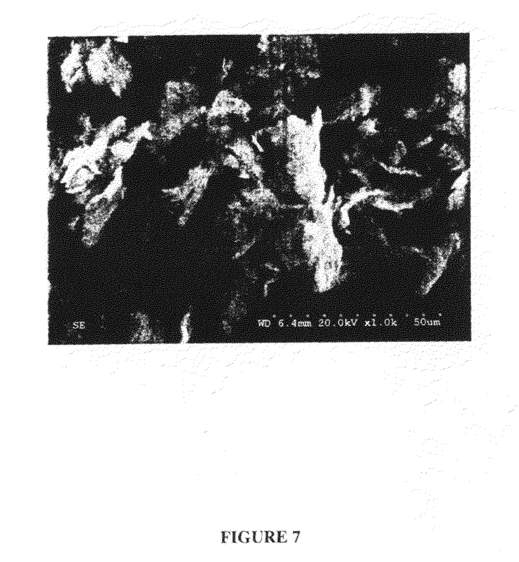

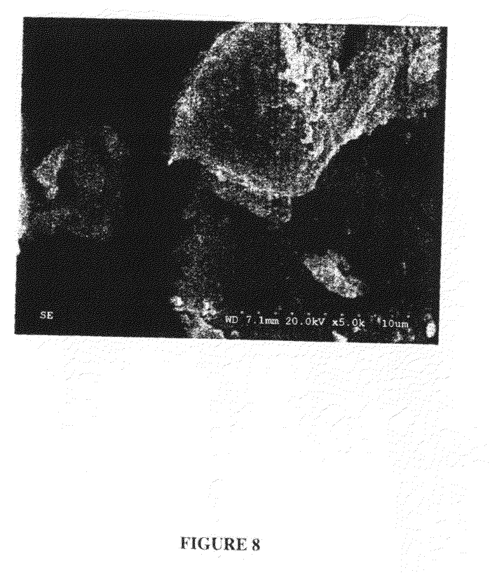

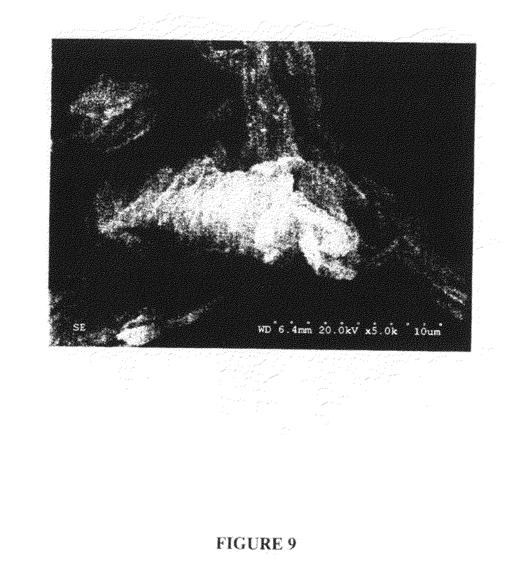

FIGS. 6 to 9 show SEM micrographs of Al—KCl (50 wt %) powder mixtures that were mechanically alloyed for 15 min. The particles were irregular, often agglomerated and their size varied from few to several tens of μm. The morphology of these particles changed drastically when the water-soluble salt was leached out from the powder mixture leaving only very thin and cold welded Al foils fragments behind. SEM micrographs of leached out Al are shown in FIGS. 7 and 9. These particles were highly porous and characterized by largely increased surface area. Specific surface area (SSA) measurements on leached out Al revealed that its SSA increases from 0.30 m²/g for as-received Al powder to 9.68 m²/g (˜32-fold) for 15 min alloyed powders.

### Example 7

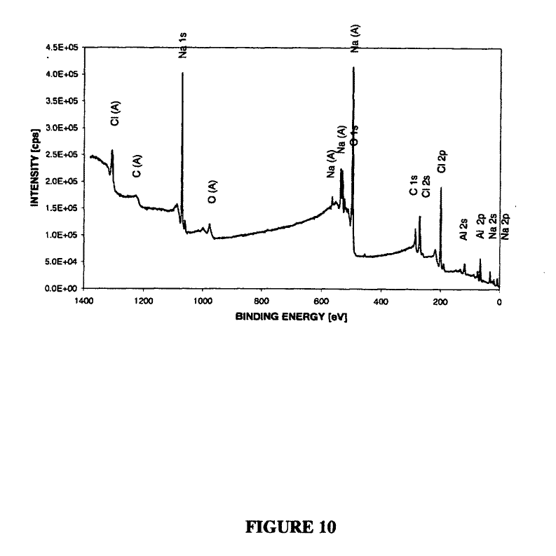

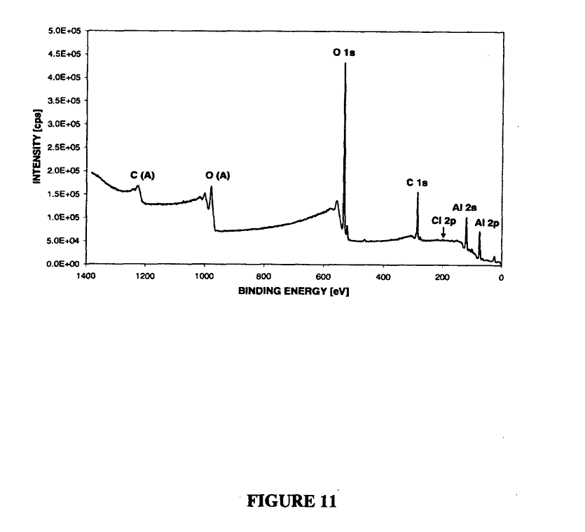

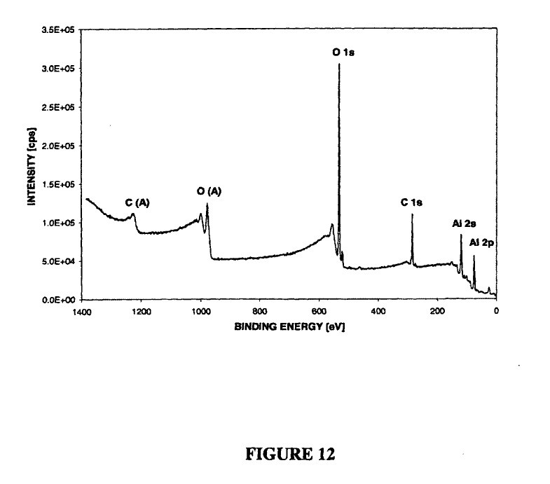

The elemental composition of the aluminum surface and chemical state of the upper 10 nm thick surface layer of metal powders was studied using XPS. FIG. 10 illustrates the XPS survey scan of Al—NaCl (50 wt %) powder mixture after ball-milling for 15 min. FIG. 11 shows the XPS survey scan of leached-out Al powder (this Al originates from Al—NaCl (50 wt %) powder mixture that was ball-milled for 15 min). FIG. 12 presents the XPS spectrum of as-received Al powders, for comparison purpose. All specimens were analyzed in the binding energy range from 0 to 1400 eV.

The XPS spectrum of leached-out Al, see FIG. 11, was very similar to the spectrum of the as-received Al and consisted of: the aluminum peaks (Al 2 p at 75.0 eV and Al 2 s at 119.8 eV); the oxygen peaks (O 1 s at 532.6 eV and O Auger at 978.2 eV); as well as the carbon peaks (C 1 s at 285.4 eV and C Auger at 1223 eV) which originated from surface contamination caused by the vapour residuals of the oil pump. Only one additional peak was found in the spectrum, a small peak of Cl 2 p at 192.6 eV.

For freshly ball-milled aluminum-salt, Al—NaCl (50 wt %), powder mixture with BM=15 min, peaks of sodium (Na 2 p at 23.72 eV, Na 2 s at 65.52 eV, Na Auger at 498.32 eV, 531.92 eV and 564.92 eV as well as Na 1 s at 1072.72 eV) and chlorine (Cl 2 p at 200.72 eV, Cl 2 s at 271.12 eV and Cl Auger at 1306.32 eV) were additionally detected and were visible in the XPS broad scan in FIG. 10.

The elemental composition of the powder particles surface obtained by XPS is given in Table 3, where two processed samples were compared with as-received Al powder. Besides a thin carbon film, that contaminates the surface and contributes largely to the analysis values (˜25 at %), the 10 nm of the near-surface predominantly consisted of oxygen (48 at %), unless salts were present in the powder matrix. Salts, which were ball-milled into Al in weight ratio 1:1, were distributed relatively evenly and covered almost half of the surface (48.7 at %). Traces of NaCl (0.3 at %) were detected in the leached-out Al. These trace amounts of salt may be found in the intergranular spacing or on the Al surface (as salt remnants from aqueous solution), which remains to be determined.

TABLE 3
The elemental composition of the Al and Al—NaCl
powders obtained by XPS.

| | Composition [at %] | | | | |
|---|---|---|---|---|---|
| Sample | Al | O | Na | Cl | C |
| As-received Al | 27.5 | 48.4 | — | — | 24.1 |
| Leached-out Al | 24.1 | 48.6 | 0.1 | 0.2 | 26.9 |
| Al—NaCl (BM = 15 min) | 14.3 | 12.0 | 22.3 | 26.4 | 25.0 |

### High Resolution XPS of O 1 s and Al 2 p:

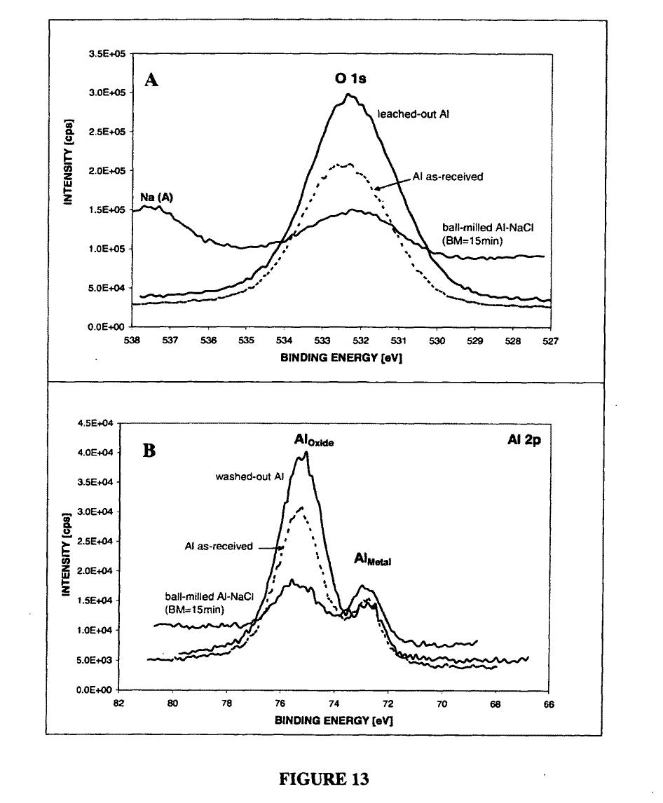

The structure, composition and thickness of the oxide layer influence largely the corrosion behaviour of aluminum in aqueous environments and dictate the surface reaction kinetics. To understand the rapid corrosion of leached out ball-milled Al in water, the collection of data relating to the oxide layer was performed. The positions of characteristic XPS peaks give information to preferred bonding and oxidation state of the atoms. The XPS O 1 s and Al 2 p were therefore analyzed in high resolution mode. FIG. 13 a) represents the narrow scans of the O 1 s and FIG. 13 b) the narrow scans of the Al 2 p core level peaks of the leached-out Al, Al—NaCl (50 wt %) powder mixtures ball-milled for 15 min, and the as-received Al powders, for comparison purpose.

The XPS O 1 s peak contained information about the bonding of oxygen and indicated the contribution of chemisorbed water, OH⁻ groups and the O²⁻ species (highest to lowest binding energy, respectively). The O 1 s peak of as-received (commercial) Al powders, see FIG. 13 a), is located at 532.25 eV and is relatively broad (2.5 to 3 eV FWHM) for all the samples. With reference to the art, it can be concluded that all three peaks (H₂O_{ad}, OH⁻ and O²⁻) may overlap and that all of the species may be present. However, the clearly predominant species in the near-surface area of the analyzed Al powders is the hydroxide or hydroxyl (OH) species (most likely bayerite, Al(OH)₃).

The XPS Al 2 p peak belonged to the Al metal and is located at 75 eV on the broad scan. However, with increasing exposure to an oxidizing atmosphere the Al 2 p peak split and its oxidic shoulder drifted from the elemental peak and grew with the growth of oxide layer thickness. By measuring the intensity ratios of the oxidic to metallic components, the oxide film thickness may be calculated.

The Al 2 p core level peaks acquired from three different powder samples contained the elemental component, Alₘₑₜₐₗ, and a broader oxide component, Al_{oxide}, to higher binding energy values in the upper 10 nm thick surface layer (FIG. 13 (b)). The Al 2 p (Alₘₑₜₐₗ) peak is located at 72.8 eV, whereas the Al 2 p (Al_{oxide}) at 75.3 eV. From the spectrum it is apparent that the oxide film thickness on the Al particles is the lowest for ball-milled Al—NaCl powders and highest for leached-out Al. The ball-milled Al—NaCl powders were freshly prepared and loaded to the XPS vacuum chamber no later than 30 minutes after ball-milling in air atmosphere. The leached-out Al powders were washed in water for approx. 3 hrs and were then air-dried for several days. Consequently, their surface was exposed to two different environments much longer and a thicker oxide film could develop. The oxide film thickness difference between leached-out and as-received Al may be attributed to different oxide growth kinetics in dry and wet atmosphere. As is known in the art, thicker oxides are grown in wet environments as demonstrated herein. Table 4 gives a rough estimation of the oxide film thickness on Al and composite powders.

TABLE 4
Aluminum oxide film thickness estimated
from Al 2p peaks intensities.

| | | | Al Oxide |
|---|---|---|---|
| | Al_{oxide}/Al_{Metal} | Al Oxide | Thickness |
| Sample | [atomic ratio] | Thickness | [nm] |
| As-received Al | 3.88/1 | 1.6 lambda* | 3.2-9.6 |
| Washed-out Al | 8.88/1 | 2.3 lambda* | 4.6-13.8 |
| Al—NaCl (BM = 15 min) | 1.15/1 | 0.8 lambda* | 1.6-4.8 |

*lambda is the inelastic mean free path of Al_{oxide} (lambda may vary between 2 to 6 nm)

Although the invention has been described with reference to certain specific embodiments, various modifications thereof will be apparent to those skilled in the art without departing from the spirit and scope of the invention as outlined in the claims appended hereto.

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

We claim:

1. A microporous metal capable of producing hydrogen upon reaction of said metal with water having a neutral or near-neutral pH.

2. A method for preparing a microporous metal capable of producing hydrogen upon reaction of said metal with water, said method comprising the steps of:
a) selecting a metal that is sufficiently electropositive that its bare surface will react with water; and
b) introducing micropores in the selected metal.

3. The method according to claim 2, wherein the micropores are introduced by metallurgical or mechanical deformation means.

4. The method according to claim 3, wherein micropores are introduced by mechanical deformation comprising the steps of:
a) providing metal particles;
b) selecting a deforming agent suitable for micropore formation in said metal particles;
c) combining the metal particles and the agent to produce an intermediate microporous composition; and
d) removing the agent from the composition to render a pure or substantially pure microporous metal powder.

5. The method according to claim 4, wherein said metal particles and said agent are in intimate physical contact during combining.

6. The method according to claim 5, wherein said intimate physical contact is achieved by milling said metal particles and said agent.

7. The method according to claim 6, wherein said deforming agent is citric acid, ice, dry ice, PVA, organic waste, a short chain organic polymer or a water-soluble inorganic salt.

8. The method according to claim 7, wherein said agent is NaCl or KCl.

9. The method according to claim 7 or 8, wherein said agent is pre-treated.

10. The method according to claim 9, wherein said pre-treatment comprises pre-milling said agent.

11. The method according to claim 7 or 8, wherein said agent is removed by melting, sublimation, leaching or washing out.

12. The method according to claim 4, wherein said metal particles and said agent are present in a ratio of between about 1000:1 and about 1:1000 by weight.

13. The method according to claim 4, wherein said agent is in the form of particles, and wherein said metal particles and said agent particles are particles in the size range between 0.01 μm and 10000 μm.

14. The method according to claim 13, wherein said metal particles and said agent particles are particles in the size range between 0.01 μm and 100 μm.

15. The method according to claim 4, wherein said metal particles are selected from the group consisting of aluminum (Al), magnesium (Mg), silicon (Si) iron (Fe) and zinc (Zn).

16. The method according to claim 15, wherein said metal particles are aluminum (Al).

17. A microporous metal produced according to the method of any one of claims 4 to 16.

18. The metal according to claim 17, wherein the metal powder comprises a volume fraction of micropores from about 0.05 to about 0.80.

19. The metal according to claim 17, wherein the metal powder comprises microporous structures having a diameter of at least 0.01 μM and a volume of at least 1000 nm³.

20. The metal according to claim 17, wherein the metal powder is characterized by an increase in surface area as compared to the metal particles.

21. The metal according to claim 20, wherein the surface area of the metal powder is from about 1 to about 1000 fold that of the metal particles.

22. The metal according to claim 21, wherein the metal powder is characterized by an increase in surface area of about 32 fold.

23. The metal according to claim 17, wherein the metal powder is characterized by a change in surface morphology as compared to the metal particles.

24. The metal according to claim 23, wherein the metal powder is characterized by a thin and cold-welded foil fragment morphology.

25. A method for producing hydrogen comprising the steps of:
a) providing a microporous metal powder; and
b) exposing the microporous metal powder to water to generate hydrogen, wherein said water has a pH of between about 4 and 10.

26. The method according to claim 25, wherein said water is at a pH of between 4 and 9.

27. The method according to claim 25, wherein the temperature of said water is 55° C.

28. The method according to claim 25, wherein the water is selected from the group consisting of fresh, spring, tap, distilled, filtered and marine water.

29. The method according to claim 25, wherein said reaction occurs in an open or closed system.

30. The method according to claim 29, wherein said reaction occurs at a pressure between about 1 and about 1000 atm.

31. The method according to claim 25, further comprising the step of c) optionally adding one or more additives.

32. A microporous metal system for generating hydrogen from a water split reaction, said system comprising:
a) a metal according to any one of claims 17-24;
b) water; and
c) a means for containing the system.

33. The system according to claim 32, wherein said system has been adapted for a device requiring a hydrogen source.

34. The system according to claim 33, wherein said device is a hydrogen fuel cell.
